(19) United States
(12) Patent Application Publication
(10) Pub. No.: US 2005/0072603 A1
(43) Pub. Date: Apr. 7, 2005

(54) Weigh deck

(76) Inventors: Frank J. Criscione II, Gladstone, MO (US); Randy Lee Vire, Clarksville, AR (US); Robert G. Jones, Dartmouth (CA); Ralph A. Miller, Parkville, MO (US)

Correspondence Address: SPENCER, FANE, BRITT & BROWNE, 1000 WALNUT STREET, SUITE 1400, KANSAS CITY, MO, 64106-2140, US

(21) Appl. No.: 10/678,982

(22) Filed: Oct. 3, 2003

(51) Int. Cl. G01G 21/00

(52) U.S. Cl. 177/126

(57) ABSTRACT

Apparatuses and methods for weighing a product along a product determination and separation line are provided. A conveyor assembly is positioned on a load cell to determine a combined weight of the conveyor assembly and the product that is being transported by the conveyor assembly. The frame of the conveyor assembly includes several pivot connections. A first pivot connection allows the moving surface of the conveyor assembly to be rotated from an operating position to a position in which the underside of the conveyor assembly can be easily cleaned. A second pivot connection is located between two portions of a support for a conveyor belt. The second pivot allows for easy application and release of tension on the conveyor belt for assembly and disassembly.

### FIELD OF THE INVENTION

The present invention relates to methods and apparatuses for weighing a product/item along a product determination and separation line.

### BACKGROUND OF THE INVENTION

In food processing facilities, it is typically necessary to select a single article/object or food item from a bulk load of such food items and to then weigh the food item for purposes of pricing the food item or for meeting particular specifications related to the food item. Once the weight for the food item has been determined, it is then often necessary to place the food item into a segregated location along with a group of other food items having a target weight. Generally, apparatuses and methods for determining weight of food items require that a single food item be removed from the bulk load at a first location, placed on a conveyor at a second location, and then moved via the conveyor across a device for measuring the weight. Once the weight of the item is determined, the food item is removed from the conveyor through the use of a flipper arm ejector (deflection arm) that deflects the item into a holding bin or other receptacle.

Referring now to FIG. 2, a prior art food weighing and separation process line, 10, will be described. In FIG. 2, bulk product 13 is delivered to product delivery station 12 where it rotates on turntable 14 until vacuum pickup head 22 mounted on pickup arm 24 of product transfer station 28 separates or captures an individual product 20a from the bulk product 13 rotating on turntable 14. As central shaft 26 of product transfer station 28 rotates, the captured individual products, 20a, are delivered to takeaway conveyor 32 and deposited on conveyor 32 to provide released individual product 20b. The rotational rate of central shaft 26 is controlled by computer 38 such that spacing is provided between each released individual product 20b thus creating the spacing shown by bracket S in FIG. 2. Spacing S designates the spacing between released individual product 20b and weight station approaching product 20c.

After captured individual product 20a has been released by pickup arm 24 onto takeaway conveyor 32, it is moved by conveyor 32 toward weighing conveyor 36 where individual product 20d is moved across load cell 44 which is positioned underneath belt 46 of weighing conveyor 36. As shown in FIG. 2, the rotational rate of central shaft 26 of product transfer station 28 creates a spacing S such that when a weighed product 20d is positioned directly on load cell 44, approaching individual product 20c is on weighing conveyor 36 but is not on load cell 44 and departing product 20e has been moved off of load cell 44 after being weighed. In this manner, only a single product is positioned on load cell 44 at any one time so that the appropriate weight of a single item can be measured. After an individual product has been weighed on load cell 44 and such weight has been registered by computer 38, the product is moved off of load cell 44 by weighing conveyor 36 into position 20e of a departing product. The departing product 20e is moved to the end of weighing conveyor 36 and transferred onto distribution conveyor 48.

Once the individual product 20f is placed on distribution conveyor 48, it is deflected into the appropriate distribution bin 50A-H by one of deflection arms 42. Deflection arms 42 are activated by a signal from computer 38. Computer 38 activates a particular deflection arm 42 in response to the particular weight of individual product 20 which has been measured by load cell 44 of weighing conveyor 36. Therefore, as individual product 20f moves onto distribution conveyor 48, one of deflection arms 42 is caused to open by computer 38. In the particular case shown in FIG. 2, deflection arm 42 associated with bin A is opened by a signal from computer 38 and product 20f is scooped or pushed off of distribution conveyor 48 and into bin A by deflection arm 42 associated with bin A.

In such a separation process line, there will be instances in which the weight of the product being moved cannot be determined for one reason or another. Such products for which the weight cannot be determined are allowed to proceed down the length of distribution conveyor 48 without being deflected into one of bins A-H. At the end of distribution conveyor 48, the non-standard product 52 is deposited onto recirculation conveyor 54. Such a non-standard product may be transferred back to product delivery station 12 or it may be rejected entirely, or it may be acted upon a worker so that the non-standard product 52 is adjusted to conform to the standard configuration of products 13. It will be appreciated that in the case of line 10 such non-standard products could be a product which is overweight or underweight, or an instance in which pickup arm 42 has picked up two products from turntable 14 rather than one. Such a double product pickup would deposit two products simultaneously onto takeaway conveyor 32 thus producing an overweight situation at weighing station 34. Alternatively, non-standard products 52 could be products that are to be rejected such as those that are off color or deformed in some particular fashion or otherwise not acceptable products, or too close to each other for separation into bins 50A-H at distribution conveyor 48.

FIG. 1 shows a side cross-sectional view of the prior art weighing conveyor (weigh deck), 36, used in process line 10 described above with respect to FIG. 2. As is shown in FIG. 1, load cell 44 of weighing conveyor 36 is positioned between two deadplates, 41a and 41b. Load cell 44 and dead plates 41a and 41b are mounted to frame 43. Conveyor belt 46 surrounds load cell 44 and dead plates 41a and 41b, and is mounted to frame 43 via rollers 45. As conveyor belt 46 rotates causing an item, such as product 20, to move across the top surface of conveyor 36, the item will travel across first dead plate 41a, then onto and across load cell 44, and finally onto and across the second dead plate 41b.

Because the item being weighed by weighing conveyor 36 is continuously in motion across load cell 44 via belt 46, the accuracy and/or precision of the measurement from load cell 44 is relatively low. This low accuracy and/or precision can be extremely undesirable in food processing facilities in which item weights are often relatively low and/or in which item pricing is based upon the weight. Therefore, it is desirable to provide an apparatus and method of weighing a product along a product determination and separation line that has increased accuracy and precision.

In addition to the relatively low accuracy and/or precision of prior art weighing conveyors, such devices are less than desirable because they are difficult to clean and maintain. Cleaning is of particular importance in food processing facilities due to health regulations and general hygiene and sanitation concerns. Generally, cleaning of a weighing conveyor requires removal of the conveyor belt. The removal of the conveyor belt in the weighing conveyors of the prior art, either for cleaning, maintenance or belt replacement, requires either disassembly of the belt itself or disassembly of the conveyor when a continuously woven belt is utilized. Such disassembly can be extremely difficult and time consuming, thus reducing the overall efficiency of the facility. Therefore, it is desirable to provide an apparatus for weighing a product along a product determination and separation line that is easy to clean and maintain.

### SUMMARY OF THE INVENTION

An object of the present invention is to provide apparatuses and methods for weighing a product in a product determination and separation line. Another object of the instant invention is to provide apparatuses and methods for weighing a product in a product determination and separation line that provide increased accuracy and precision over the prior art. A further object of the present invention is to provide apparatuses and methods for weighing a product in a product determination and separation line that allow for easy service, cleaning and maintenance.

In order to overcome the difficulties with the prior art and achieve the above-described objects, the instant invention provides a weigh deck that is positioned on a load cell. The load cell determines the combined weight of the weigh deck assembly and the object that is to be weighed. A computer then subtracts the known weight of the weigh deck assembly from the combined weight to determine the weigh of the item. This is particularly useful for weighing small items that might not normally register on a load cell. Additionally, the position of the weigh deck on the load cell increases the accuracy and precision of the measured weight by decreasing vibration caused by continuous motion across the load cell, as is present in the prior art.

In one embodiment of the instant invention, the inventive weigh deck includes a pivot, or hinge, connection between two portions of a support member for a conveyor belt. This hinge connection allows the release of belt tension to provide for easy removal and replacement of the conveyor belt without needing to disassemble either the weigh deck or the conveyor belt.

Another embodiment of the instant invention includes a pivot/hinge connection between a conveyor belt support member of the assembly frame and a base member of the frame. This hinge connection allows the conveyor support portion of the weigh deck to be rotated upward from the base portion to allow for easy cleaning and maintenance of the entire assembly.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention maybe employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a side cross-sectional view a prior art weigh deck assembly

FIG. 2 is a top view of a product determination and separation process line that includes the prior art weight deck shown in FIG. 1.

FIG. 3 is a perspective view of a weigh deck of the instant invention.

FIG. 4 is a perspective view of the weigh deck of FIG. 3 showing the conveyor assembly in a cleaning position.

FIG. 5 is a perspective view of the weigh deck of FIGS. 3 and 4 showing the conveyor assembly in a belt removal/replacement position.

### DESCRIPTION OF A PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

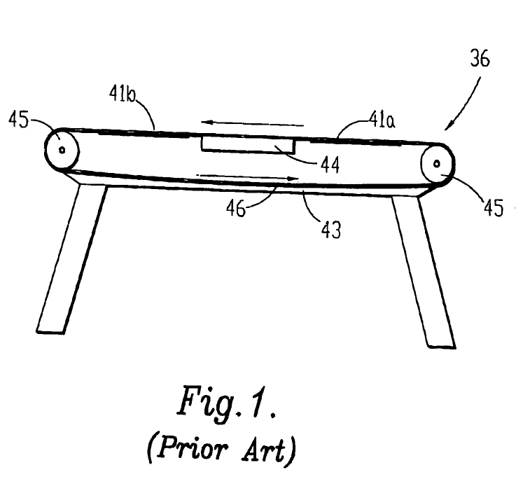

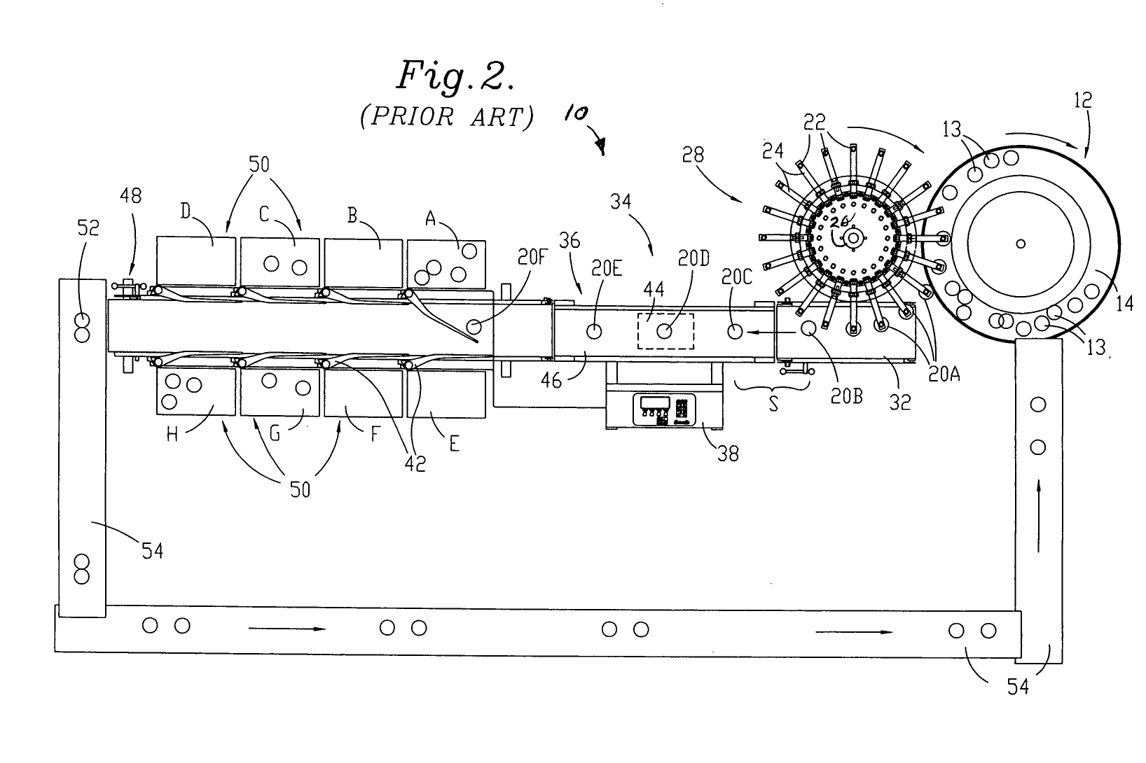

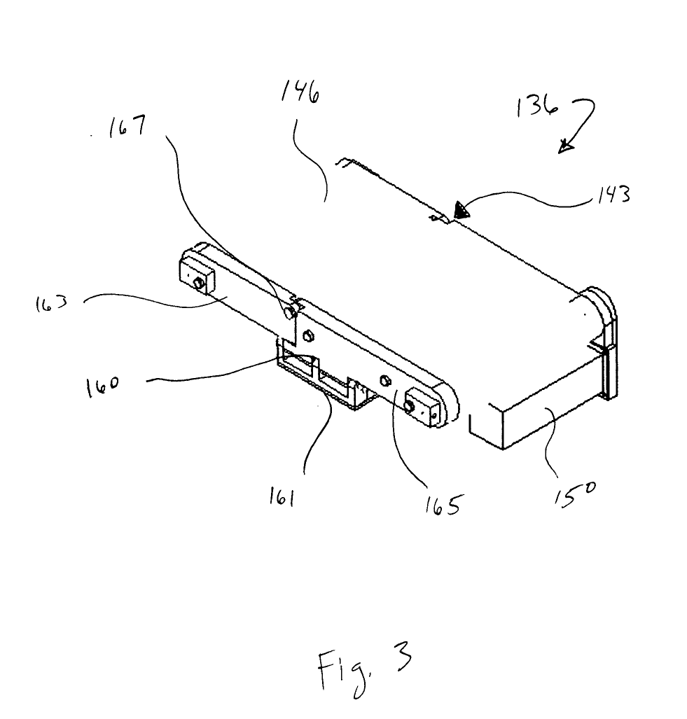

Referring to FIGS. 3-5, a weigh deck, 136, is shown which serves as a replacement for the prior art weigh deck, 36, located in the product determination and separation line of FIG. 2. As is shown in FIGS. 3-5, weigh deck 136 of the instant invention does not require the addition of dead plates 41a and 41b (shown in FIG. 1) which are necessary to the proper operation of the prior art weigh deck. The elimination of dead plates 41a and 41b permits greater flexibility in the dimensions of the device, such that weigh deck 136 of the instant invention can be constructed to have the same dimensions and thus occupy the same footprint as weigh deck 36 of the prior art, or alternatively, weigh deck 136 can be constructed using reduced dimensions, minimizing the weigh deck footprint and thus the overall length of the process line.

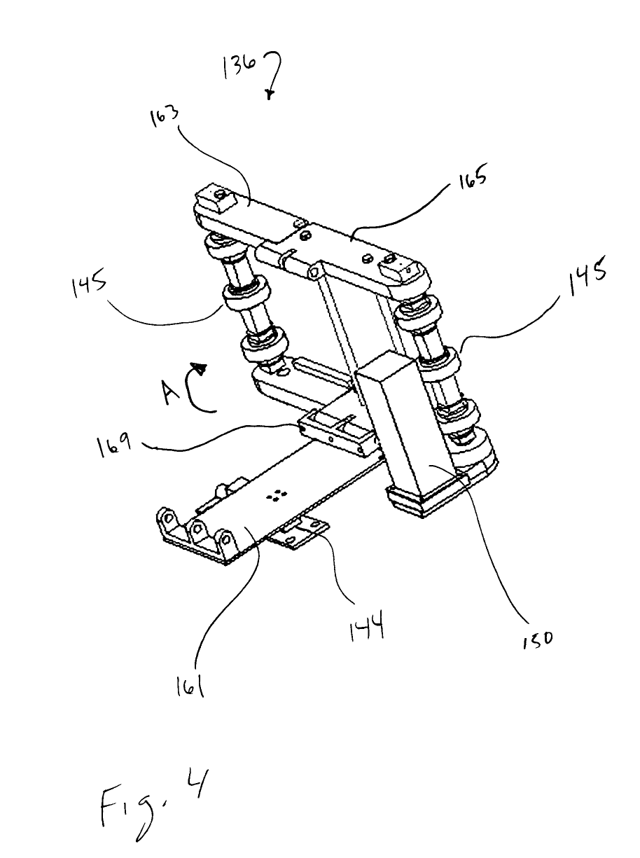

FIG. 3 shows weigh deck 136 fully assembled in its operational state as it would be while the product determination and separation process line is online. Weigh deck 136 includes frame 143 positioned on load cell 144 (shown in FIG. 4). Conveyor belt 146 is mounted to rollers 145 (shown in FIG. 4) which are attached to a conveyor belt support portion of frame 143 via bearings that allow for rotation of rollers 145. The conveyor support portion of frame 143 includes support members/portions 163 and 165 connected together via pivot/hinge connection 167. Conveyor support member 165 of the conveyor support portion of frame 143 is pivotally connected to base member 161 of frame 143 via hinge connection 169 (shown in FIG. 4). Conveyor support member 165 is also connected via releasable connection 160 to base member 161, to prevent unwanted rotation of the conveyor support portion of frame 143 relative to base member 161 during operation of weigh deck 136. Motor 150 is mounted to conveyor support member 165 and is connected to rollers 145 to provide rotation to rollers 145, which in turn provides for rotation of belt 146.

Referring to FIG. 4, weigh deck 136 is shown with releasable connection 160 disengaged, conveyor belt 146 removed, and with the conveyor support portion of frame 143 in a non-operational, cleaning/maintenance position. In FIG. 4, the conveyor support portion of frame 143, including portions 163 and 165, is shown rotated upward in direction A with respect to base member 161. In the preferred embodiment, releasable connection 160 includes a bolt, hitch pin or the like that is inserted through a series of aligned cylindrical brackets located on both support member 165 and base member 161, similar to a common door hinge. Also, in the preferred embodiment, both pivot connection 169 and releasable connection 160 are constructed in the same manner, such that removal of the bolt (or pin, etc.) from either connection will allow for the rotation (pivot) of the conveyor support portion of frame 163 with respect to base member 161, as is shown in FIG. 4. Rotation upward of the conveyor support assembly from base member 161 provides for easy cleaning and maintenance of the assembly.

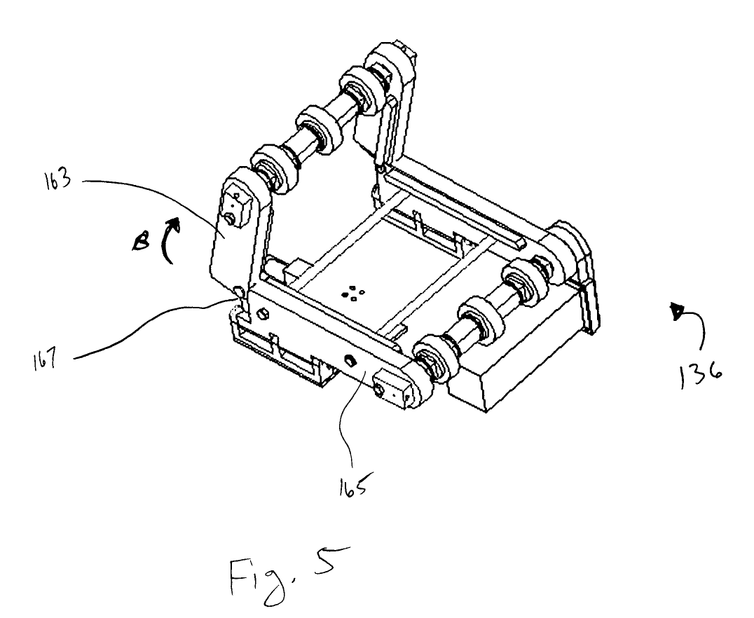

Referring to FIG. 5, weigh deck 136 is shown in a non-operational, cleaning/maintenance position for removal and replacement of conveyor belt 146. In FIG. 5, conveyor support member 163 is rotated upward in direction B from its operating position which is parallel to and aligned with conveyor support member 165 (as is shown in FIGS. 3 and 4), to a position that is generally perpendicular to conveyor support member 165. Pivot connection 167 allows for the rotation of support member 163 with respect to support member 165. The rotation of support member 163 with respect to support member 165 reduces the distance between the ends of support members 163 and 165, such that tension on belt 146 is released and belt 146 can thus be removed from the assembly and cleaned/replaced. Once a new belt is positioned on the assembly, support member 163 is rotated downward back to its operational position parallel to support member 165 and tension is again applied to belt 146. A locking mechanism (not shown) can be included to hold support member 163 in its operational position (shown in FIG. 3) during rotation of the conveyor belt. Such will prevent unwanted rotation of support member 163 with respect to support member 165.

In the preferred embodiment, motor 150 is a stepper motor which provides high output and high torque in a relatively small package. Motor 150 is controlled by a computer, such as computer 38 of the prior art process line, which synchronizes the speed of motor 150, and thus the speed of conveyor belt 146, to the entire process line in the same or similar manner as is accomplished with respect to the prior art weigh deck shown in and discussed with respect to FIG. 2. It is recognized however that the structural arrangement of the instant invention requires that only a single item/product be located on weigh deck 136 at one time, otherwise the weight of all items located on conveyor belt 146 of weigh deck 136 will be registered. This is because the weight of the entire assembly of weigh deck 136 acts upon load cell 144. Thus, depending upon the length of weigh deck 136, it may be necessary to adjust the speed of conveyor belt 146, the process line, or both to ensure that only a single item is located on weigh deck 136 at any given time. For example, if weigh deck 136 is constructed to the same length as weigh deck 36 located in process line 10 of FIG. 2, speed adjustment will be necessary to avoid having three items, 20c, 20d, and 20e, all located on weigh deck 136 at one time. As it may be undesirable to slow down the speed of the entire process line, it may be preferred to increase the speed of conveyor belt 146 above the speed that would be utilized for the prior art weigh deck. As increasing the speed of conveyor belt 146 to ensure that only a single item 20 is located on weigh deck 136 at one time could result in a speed for conveyor belt 146 that is approximately three times the speed of the rest of process line 10, it may be preferable to reduce the length of weigh deck 136 so that the speed of conveyor belt 146 relative to the rest of the process line will be consistent.

The operation of a process line that utilizes weigh deck 136 of the instant invention will be very similar to that of the process line discussed with respect to FIG. 2 and the prior art weigh deck, 36. Thus, the operation of weigh deck 136 shall be discussed herein with reference to FIG. 2, in which prior art weigh deck 36 has been replaced with weigh deck 136, and individual items 20c, 20d and 20e have been replaced by a single item. After captured individual product 20a has been released by pickup arm 24 onto takeaway conveyor 32, it is moved by conveyor 32 toward weigh deck 136 where an individual item (product) is moved across weigh deck 136 via belt 146. Weigh deck 136 is positioned on load cell 144 such that the combined weight of weigh deck 136 and the individual item located on weigh deck 136 acts upon load cell 144. As is discussed above, the rotational rate of central shaft 26 of product transfer station 28 and the speed of conveyor belt 146 create a spacing such that when a weighed product is positioned directly on weigh deck 136, approaching individual product 20b is not yet on weigh deck 136 and departing product 20f has been moved off of weigh deck 136 after being weighed. In this manner, only a single product is positioned on weigh deck 136 at any one time so that the appropriate weight of a single item can be measured in combination with the weight of weigh deck 136 as the item moves across weigh deck 136. After the combined weight of weigh deck 136 and an individual product has been obtained on load cell 144 and such combined weight is registered by computer 38, the product is moved off of weigh deck 136 into position 20f of a departing product onto distribution conveyor 48. Computer 38 then determines the weight of the individual product by subtracting the known weight of weigh deck 136 from the combined weight of the product and weigh deck 136. The known weight of weigh deck 136 can be set and fixed as a constant into computer 38, or it can be determined by registering the weight of weigh deck 136 with load cell 144 during an interval when no product is located on weigh deck 136.

Once the individual product 20f is placed on distribution conveyor 48, it is deflected into the appropriate distribution bin 50A-H by one of deflection arms 42. Deflection arms 42 are activated by a signal from computer 38. Computer 38 activates a particular deflection arm 42 in response to the particular weight of individual product 20 which has been calculated by computer 38. Therefore, as individual product 20f moves onto distribution conveyor 48, one of deflection arms 42 is caused to open by computer 38. In the particular case shown in FIG. 2, deflection arm 42 associated with bin A is opened by a signal from computer 38 and product 20f is scooped off of distribution conveyor 48 and into bin A by deflection arm 42 associated with bin A.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive apparatus and methods are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A weigh deck comprising:
a load cell; and
a conveyor assembly associated with said load cell such that a weight of said assembly acts upon said load cell; and
wherein said conveyor assembly comprises a first frame member, and a second frame member pivotally connected to said first frame member.

2. The weigh deck as claimed in claim 1 wherein said first and second frame members together support a conveyor belt.

3. The weigh deck as claimed in claim 1 wherein either said first or second frame members support a conveyor belt.

4. The weigh deck as claimed in claim 2 wherein said conveyor assembly further comprises a base member pivotally connected to at least one of said first and second frame members.

5. The weigh deck as claimed in claim 4 wherein said base member is positioned on said load cell.

6. The weigh deck as claimed in claim 1 wherein one of said first and second frame members is a conveyor belt support and the other of said first and second frame members is a base member.

7. The weigh deck as claimed in claim 6 wherein said conveyor belt support comprises a first portion and a second portion pivotally connected to said first portion.

8. The weigh deck as claimed in claim 6 wherein said base member is positioned on said load cell.

9. A weigh deck comprising:
a first frame member;
a second frame member pivotally connected to said first frame member; and
a conveyor belt supported by at least one of said first and second frame members.

10. The weigh deck as claimed in claim 9 further comprising a load cell associated with at least one of said first and second frame members such that a weight of the weigh deck acts upon said load cell.

11. The weigh deck as claimed in claim 9 wherein said first and second frame members together support said conveyor belt.

12. The weigh deck as claimed in claim 9 wherein one of said first and second frame members is a conveyor belt support and the other of said first and second frame members is a base member.

13. The weigh deck as claimed in claim 12 wherein said base member is positioned on a load cell.

14. The weigh deck as claimed in claim 12 wherein said conveyor belt support comprises a first portion and a second portion pivotally connected to said first portion.

15. A weigh deck comprising:
a conveyor;
a support member for a conveyor;
a base member pivotally connected to said support member; and
a load cell associated with said base member such that a weight of the weigh deck acts upon said load cell.

16. A weigh deck comprising:
a conveyor;
a support member for a conveyor, said support member comprising a first portion and a second portion pivotally connected to said first portion; and
a load cell associated with at least one of said first and second portions such that a weight of the weigh deck acts upon said load cell.
